(19) United States
(12) Patent Application Publication
(10) Pub. No.: US 2006/0026015 A1
(43) Pub. Date: Feb. 2, 2006

(54) Two part marketing communication form configuration having interactive detachable user piece, method of using same and marketing kit for distribution

(76) Inventors: Raymond D. Roberts JR., South Bend, IN (US); Donna J. Sowards, Pleasanton, KS (US)

Correspondence Address: WARD KRAFT, INC., P.O. BOX 938, FORT SCOTT, KS, 66701, US

(21) Appl. No.: 10/909,441

(22) Filed: Aug. 2, 2004

(51) Int. Cl. G06Q 99/00

(52) U.S. Cl. 705/1; 705/14

(57) ABSTRACT

The present invention relates to a business communication marketing piece that includes a high color printed first portion containing a particular marketing message and a second portion having a removable interactive component that may be used to demonstrate the product or message provided in the communication. The business form is preferably created from first and second parts that are connected to one another through use of an adhesive strip or bonding strip. The marketing communication is preferably a multicolor piece that uses at least two and typically four colors on each side of the first part. The specification further describes a business form marketing kit and an exemplary method of using the business communication piece.

### CROSS-REFERENCES TO RELATED APPLICATIONS

None.

### FIELD OF THE INVENTION

The present invention is found in the field of marketing communications. More particularly the present invention relates to the endeavor of marketing business forms that have one or more removable or detachable pieces that may be used by the end user or recipient to better understand the marketing communication or immediately engage in a particular activity. The marketing communication of the present invention may be used in connection with the introduction of new products, stimulating sales of existing products, providing complimentary information to accompany the detachable interactive user piece, such as a map or description of places or events for a particular location as well as many other applications. The marketing communication of the present invention may be included as part of a marketing distribution kit or transmitted individually to an intended recipient. The invention described in the present specification also includes a method of using the marketing communication in an effort to facilitate the use and sales of the particular product or service that is being marketed by the manufacturer or distributor.

### BACKGROUND OF THE INVENTION

There are numerous marketing pieces that have been created over the years to stimulate sales of products and services. Typically such marketing materials take the form of printed pieces that describe the product or services and are then handed out or mailed out to individuals. Such pieces are commonly referred to as “sell sheets” and contain a relatively generic recitation of information about a particular product or service that is being offered by the manufacturer or distributor of the piece. The recipient is then given the opportunity to call and request samples of the products which may or may not be sent to requestor depending on the seriousness of the inquiry. Such sell sheets have historically resulted in a very low response rate to the product or service that is described in the piece. That is, if ten thousand sheets are distributed perhaps only one percent (one hundred) of the sell sheets results in inquires for further information about the products or services. Such inquiries are then funneled to a sample library or marketing group who then packages up a number of samples and forwards the material to the requester in the hopes that a quotation for an order will arrive.

The difficultly of such a two step processes, initially sending information and then sending samples when a inquiry is received from a potential customer, is that by the time the samples arrive in the mail, the requestor may have forgotten the reason why the materials were requested or alternatively, the need for the samples has dissipated, such as the opportunity to make a sale of the products or services has passed, and the samples are then discarded by the recipient, thus defeating the overall purpose of the marketing campaign.

In addition, to the cost of preparing numerous sell sheets, the giving or distributing of free samples has heretofore been a substantial expense encountered by business form manufacturers and distributors and as such the activity severely limits the extent of marketing that can be done by the manufacturer because of the substantial cost that is involved in the process. When samples are requested by a potentially interested individual, the request may be for a relatively large number of samples such as 50 or more when in actuality the individual may only need one or two to leave at a potential user site for inspection and review, hoping to leave additional specimens at other locations. However, if other potential customer calls are not scheduled or the original stop does not request any additional samples, a large portion of the sample may go unused and are often then destroyed or discarded.

With the rise of e-mails and fax machines marketing collateral has also been delivered electronically as well as distributed via telephone lines to facsimile machines. The costs associated with such transmission means is very attractive and enables the manufacturer or distributor to quickly distribute communications to a large number of e-mail addresses or facsimile machines relatively economically. However, such messages can be perceived by the recipient as an annoyance.

While electronic messages can deliver colored illustrations in connection with the advertising piece or collateral that is being sent, the size of the transmitted file, due to the color or graphics, may unfortunately consume too much space on a computer or the e-mail simply may be deleted prior to opening as the recipient treats it as SPAM or an unwanted electronic message.

Facsimiles can be delivered directly to a designated recipient or at least to a machine that is located at the recipient's office. However, one difficulty with marketing to individuals via facsimile is that the copy which is produced by the facsimile machine is normally limited to a black and white document which attracts little if any attention. Moreover, the facsimile may be quickly discarded by the first individual encountering the piece on the facsimile and not the person who might have an interest in the message that has been communicated to the location.

In addition, with the rise of the use of such technologies, namely e-mails and facsimiles, has come the demand from consumers for greater protection from this seeming incursion to one's privacy. This out cry has led to the drafting of protectionist legislation that is designed to protect the privacy of intended recipients of these communications. Thus, in order to use e-mail messaging and facsimile, the marketer must first obtain the written consent of the intended recipient prior to sending the e-mail or facsimile to the particular person.

The difficulty with this situation is that even after the consent is obtained, there is still no better or effective way than that set forth above in requiring the recipient to request a sample of the product or service offering which again, by the time the product or offering arrives, the requester may have forgotten the reason for the sample or the opportunity for which the sample might have worked may have vanished.

In addition to marketing products and services to end users there may be other applications in which it is desirable to provide a marketing piece in connection with a removable and immediately useable component.

What is needed therefore is an integrated marketing communication which maximizes the impact of a particular message by providing an interactive portion that is immediately useable as part of the communication that has been distributed to the end user or recipient.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Unexpectedly, it has been found that by combining a sample business communication product such as a business form, with a multiple color marketing piece, response rates can be dramatically improved in connection with the marketing of products and services related to the business communication industry. The subject of the instant specification pertains to a unique business form marketing piece as well as a kit for using the marketing business form that includes an interactive, immediately useable sample that can be used to demonstrate the business form that is the subject of the communication in combination with a high color collateral piece.

In one exemplary embodiment, a business form marketing communication piece is described and includes a business form that has a first part with front and back faces. Each of the front and back faces is printed with a marketing communication that includes at least two colors which do not include white or clear, but may include four colors or more. The first part has first and second side edges and first and second end edges.

In this presently described embodiment, the business form includes a second part that has front and back faces as well as first and second side edges and first and second end edges. The second part of the business form has at least one separable element, and is joined to the first part along one of the side edges or end edges. The separable element is selected from a group including wristbands, cards, labels, tags, tickets and combinations thereof.

The separable element provided in this assembly is used to provide an interactive business form component that is capable of demonstrating the use of the component in cooperation with the marketing communication that has been provided on the first part of the business form assembly.

In a still further exemplary embodiment of the present invention includes a method of marketing a business form product or business communication service, comprising the steps of initially assembling a first data set that relates to a product or service and then preparing a full color layout for the product or service having at least two and up to at least four distinct colors other than white or clear. Next, a business form is obtained that has at least a first part with the first part having first and second faces.

At least a first marketing communication is printed of the first part on one of the first and second faces using the full color layout. Then a second part is provided which has at least one removable element. The second part is connected to the first part along an edge of each of the first and second parts through use of an adhesive strip to form a marketing communication. The marketing communication is then distributed and response rates to the communication are calculated.

In a yet still further exemplary embodiment of the present invention, a marketing promotional business forms product kit, is described and includes a first business form that has first and second sections. The first section is printed with at least four colors other than white or clear to provide a marketing communication. The second section of the business form is provided with a removable element that is selected from a group including magnets, cards, wristbands, tickets, labels and combinations thereof. Use of the removable element is described by the marketing communication that is printed on the first part.

At least two demonstration forms are provided in the kit with each of the demonstration business forms being substantially blank. Each of the demonstration forms has first and second sections, with one of the second sections having a removable element that is selected from a group that includes magnets, cards, wristbands, tickets, labels and combinations thereof.

The kit also includes a container that is used for holding the first business form and the at least two demonstration forms. The container may be selected from a group that includes envelopes, boxes, bags and similar structures.

In each of the foregoing embodiments, the marketing communication that is provided on the first part of the business form is selected from a group that includes maps, use directions, suggested use applications, user testimonials, product pricing information, coupons and product discounts, promotional offerings and combinations thereof.

The first and second parts of the business form construction are connected to one another along a side edge or end edge through the use of a strip of adhesive material such as adhesive tape. The first and second parts may be constructed from similar materials such as cellulosic based stock or alternatively the first part may be made from a cellulosic material and the second part from a different or distinct material such as a synthetic stock, e.g. film, plastic, or from a laminate.

The production of the marketing collateral is typically done through the use of a four color process in which four colors are printed on each side of the first part and possibly one or more of the faces of the second part. The colors typically do not include the base color of the stock material, such as white or clear and will include several additional colors that are used in the production of the marketing collateral. Use of a well known equity or character may also be used in connection with the marketing and distribution of the sample or product so as to further stimulate interest in the offering.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a front view of the business form marketing piece of the present invention;

FIG. 2 provides a back side view of the business form marketing piece of the present invention;

FIG. 3 illustrates a further marketing application for the business form assembly of the present invention;

FIG. 4 shows a block diagram providing an exemplary method of carrying out use of the business form marketing communication of the present invention; and

FIG. 5 depicts a kit which includes the marketing communication of the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

One of the most important things with respect to new products or service innovations is the need to effectively market and communicate the new products or services to potential customers and end users of the product or services. Such marketing typically includes the creation of marketing collateral that describe the features of the products and or services and the benefits and uses of those services. In addition to a description of the product or service, the collateral may include customer or end user testimonials, use descriptions, exemplary applications for using the products and services, promotional opportunities, discounts, and combinations of the foregoing.

Coupled with the need to efficiently use marketing resources is the ability to immediately provide the user with an interactive and useable sample of the business form product that is the subject of the marketing communication that has been created. The ability to conveniently and quickly place a description of a product as well as a usable sample of the business form in the hands of the potential user thus greatly increases the opportunity that the user will order business form products from the provider of the sample.

Marketing collateral as used herein includes the use of scripted or prepared material that may be distributed through printed mediums such as newspapers, trade publications, magazines, fliers, handouts and the like as well as pieces that may be transmitted by mail or courier services, or may be handed out or dispensed at public event gatherings such as trade shows, seminars, symposiums, product demonstrations and the like.

The term adhesive strip or tape is meant to include a substrate to which an adhesive coating has been applied such that when applied to a substrate the adhesive strip will hold the first and second parts of the business form assembly together. The adhesive that is used may be a permanent adhesive such that the first and second parts cannot be removed from one another without tearing of the business form or alternatively, the adhesive could be a removable or repositionable adhesive which would enable the separation of the parts from one another and then the reconnecting of the parts if desired. Adhesive tape or strip may also include binding strips, heat sealable strips and such other strip, pieces or segments that can be used to connect one piece to another.

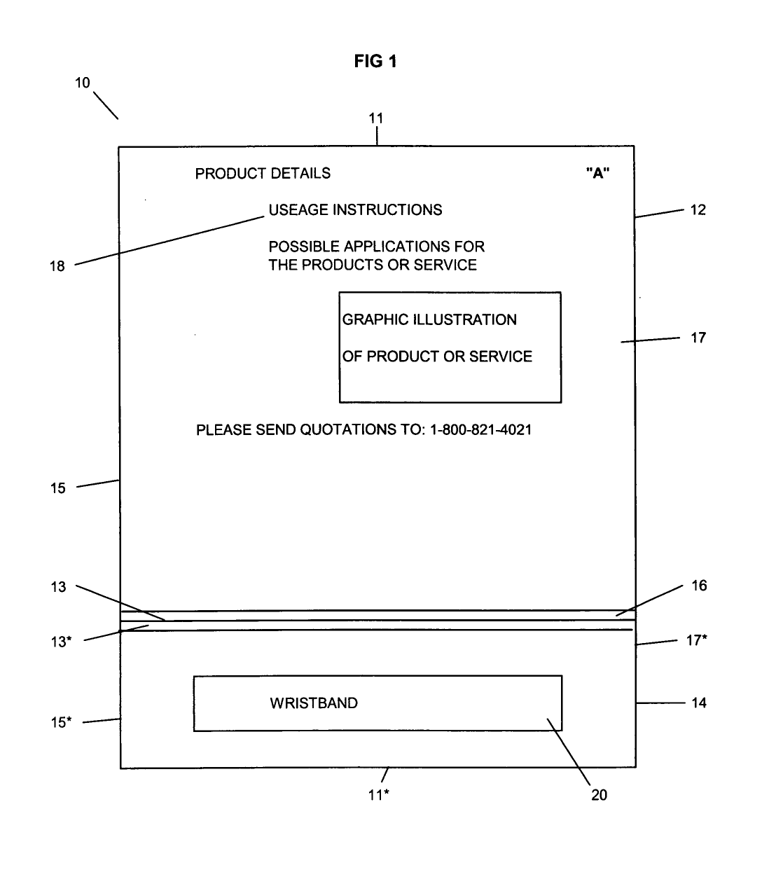

Turning now to FIG. 1 of the present invention, the business marketing communication piece is generally referred to by reference numeral 10. The piece 10 has a first part 12 and second part 14. The first part 12 may be constructed of a generally cellulosic material, such as coated paper, card or tag stock and the second part 14 may be constructed of a similar material or may be a disparate material such as a laminate or synthetic material such as plastic. The first 12 and second 14 parts are connected to one another through use of an adhesive bonding strip 16 which extends over the end edge of each of the first 12 and second parts 14.

The first part 12, is printed using a color process such as flexographic, digital imaging or such other means as are known in the industry. Typically, the first part 12 will be printed with at least two colors, excluding colors of the base substrate, white, clear, etc. and more preferably will be imaged using a four over four process in which four colors are printed on each side or face of the first part 12. The printing or imaging will include a background as well as indicia and graphics that are generally depicted by reference numeral 18. Such graphics and indicia may include but are not limited to maps, use directions, suggested use applications, user testimonials, product pricing information, coupons and product discounts, promotional offerings and various combinations thereof. The graphics and indicia are generally intended to be complementary to the product or service that is to be depicted or provided with the second part 14 of the business communication assembly 10.

The second part 14 of the assembly is provided with a detachable element 20, which as shown is a wristband. The detachable element may be selected from a group including but not limited to wristbands, cards, labels, tags, tickets and various combinations thereof. The detachable element 20 will generally be removable from the second part 14 through use of perforations, die cuts, lines of weakness or the like. The detachable element 20 is then pulled out from the second part 14 of the form assembly 10 so that the recipient can demonstrate the functionality or use the element 20 in accordance with the marketing communication 18 that was provided on the first part 12 of the assembly.

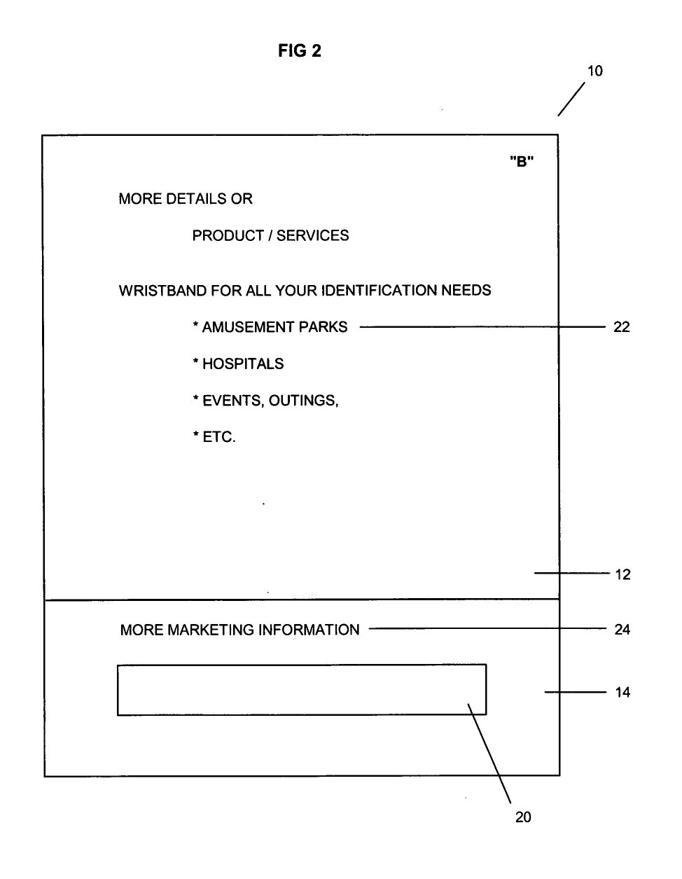

It will be readily understood that the first and second parts 12 and 14, will each have first and second sides 15, 17 and 15*, 17* respectively and first and second ends 11, 13 and 11*, 13*, respectively. As shown in FIG. 1, the first 12 and second 14 parts are joined along edges 13 and 13* through use of the adhesive strip 18. The adhesive strip may placed only on one side as shown in FIG. 1 or alternatively, the tape may be provided on both the first and second sides. As can be seen in FIG. 1, the first side or face is designated by reference to the letter “A” and as shown in FIG. 2, the second side or face is designated by reference to the letter “B”.

Reference is now directed to FIG. 2 of the presently described embodiment. In FIG. 2, the back side or face “B” of the assembly 10 is shown. The back side or face “B” of the assembly 10 is provided with additional marketing indicia generally designated by reference numeral 22. This marketing indicia 22 is also printed using a multiple color process, such as a four color process and is intended to be complimentary to the indicia 18 that was printed on the first face or side “A” of the assembly 10. By using the term complementary, the indicia is related or is a continuation of the information or indicia that is provided on the first side of the assembly. However, it should be understood that the indicia 22 may also relate to promotional offers such as the opportunity to win a vacation or other prizes should products or services advertised in the assembly be purchased. As is shown, the indicia 22 is printed on the first part 12 of the assembly 10. In addition, the second part 14 may have additional marketing indicia provided which has been designated as numeral 24. This supplemental marketing indicia 24 would preferably be related or complimentary to at least the first set of indicia 18 and would provide some general use applications of the detachable element 20 of the assembly 10.

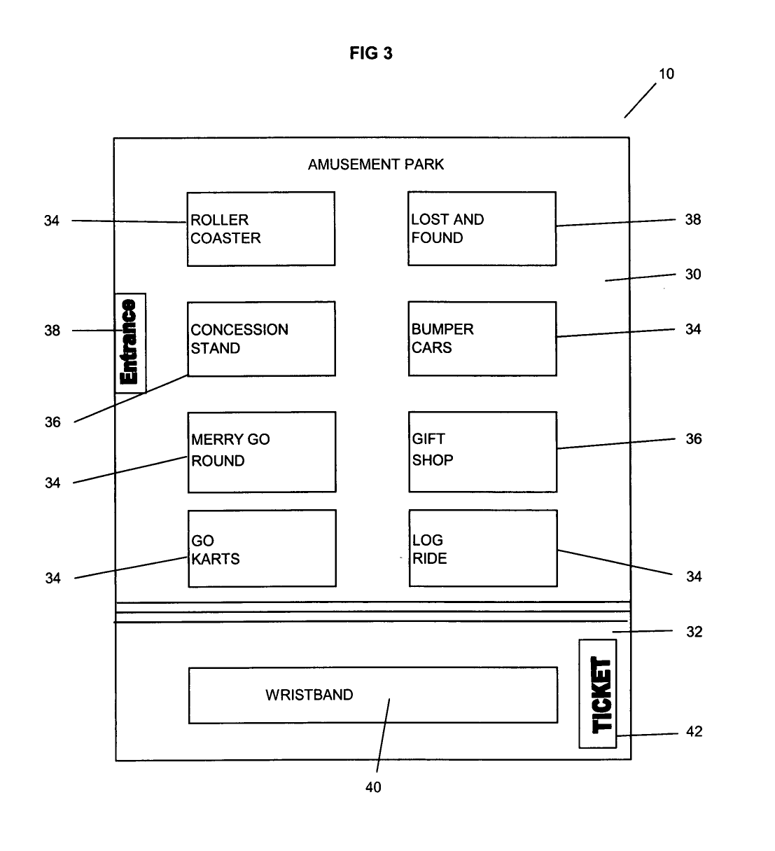

Turning now to FIG. 3 of the present specification, an alternative embodiment is described and illustrates the use of the business communication assembly 10 as a combination form including a map and detachable elements in a second part.

The map which has been created on the first part 30 is printed in a full color process using at least two colors, other than white or clear, and includes a number of attractions 34 as well as the locations of several retail outlets 36 and administrative centers 38.

The second part 32 of the form assembly 10 includes a plurality of detachable elements 40 and 42. As depicted in FIG. 2, one of the elements 40 is a wristband such as one might use as proof of admission to an amusement park and the second 42 is depicted as a ticket such as one might use for a ride or other attraction or discount off a meal or such other use as may be made. In this embodiment, an interactive component 40 and 42 allows the user, such as a parent who purchases admission tickets for his or her family to provide each member with proof of admission as well as a map in order to track or location where the family or member would like to go next.

The back side of the form assembly 10 of FIG. 2, which is not shown, may then include other relevant information for the amusement park such as hours of operation, emergency numbers or other promotional offerings from nearby retail establishments, such as hotels, restaurants and the like.

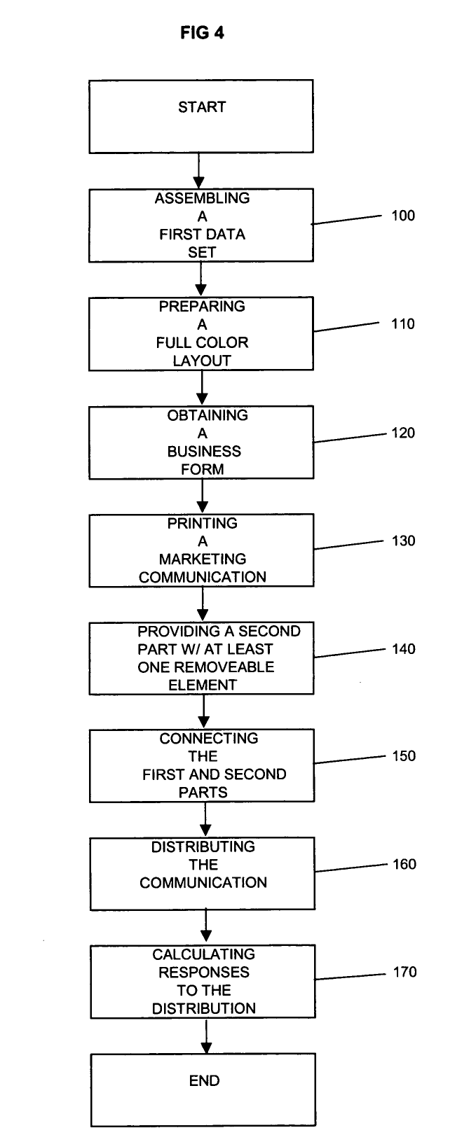

The illustration of FIG. 4 provides a block diagram for an exemplary method of using the present invention. Once the method has been started, a collection of data is collected at step 100. This data set will preferably relate to information about a product or service to be offered and will include various features, uses or applications that may be made of the product. Other information may include customer testimonials; promotional offers, discounts and such other details as may be suitable for use in connection with the preparation of the form assembly.

Next, the information that was collected in the data set at step 100 is then used to prepare a full color layout at step 110. The full color layout will preferably include at least two colors that are printed on each side of the substrate or a two over two process. The printing may occur by flexography, digital imaging, gravure or such other processes as may be suitable for creating the layout desired by the end user. In a still more preferred embodiment a four over four color process is used to create the layout. The color process will generally not include the color of the substrate such as white or clear or such other color as the substrate may have.

Once the predetermination of the color layout and data has been determined a business form stock is obtained at step 120. The stock is one that should be receptive to receiving printing or imaging such that the indicia provided on the substrate may not be wiped off or otherwise readily removed by subsequent handling of the business form. The imaging can be further made permanent by corona or treating the indicia and surface of the substrate with ultraviolet (“UV”) energy.

Once the stock is fed toward the printing apparatus, the stock is then printed or imaged at step 130 with the marketing communication information and graphics that were created at step 100. The printing can be accomplished by flexography, digital printing, non-impact imaging, gravure and such other printing technologies as are known to print and image information and graphics on substrates.

A second part that is to become part of the marketing form assembly is then provided at step 140. The second part may be constructed of the same material as the first part of the business form, or it may be constructed of a material that is distinct from the first part. For example, if the first part is a cellulosic based material the second part may be composed of a synthetic material, such as film or plastic, a laminate that may include a pressure sensitive portion or such other arrangement as may be suitable for use in the provision of sample products to the potential end user.

The first part is then joined to the second part at step are connected to one another at step 150. The parts are connected to one another though use of adhesive strips, such at tape, heat sealable films, bonding strips and the like. If a pressure sensitive tape is used, the adhesive that is used may be either a permanent, removable or repositionable adhesive depending on whether the parts are intended to be separable from one another without the necessity of tearing the parts apart.

Once the marketing communication form has been completed, the form assembly is distributed at step 160 to potential users of the products or services. The distribution list may include a general mailing to people listed in a SIC code, pre-established customers for a product or a manufacturer, attendees of a trade show, symposium, seminar or the like or such other group for which the combination marketing communication and interactive removable piece may be suitable.

After a series of the form assemblies have been distributed at step 160, response rates are calculated at step 170. Response rates include those recipients that then place a bid for quotation for possible sale of products. Other response rates may include recipients in a particular region, field of endeavor or such areas or groups that the manufacturer or provider would be interested in obtaining additional data or information. Once the response rates are calculated, the manufacturer can determine the success of the program or make modifications to the program as are necessary. Then the process ends.

In use, the recipient would review the marketing message that has been provided on the first part of the assembly and then would remove the detachable element from the second part, such as pulling up the element, and would then use or demonstrate the use of the detachable element.

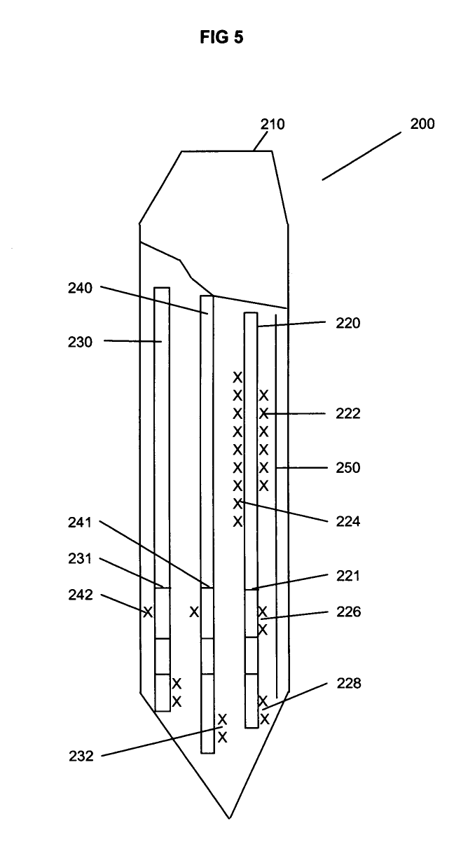

Reference in now directed to the embodiment provided in FIG. 5 of the present invention in which a kit, generally designated by reference to numeral 200 is provided. The kit 200 includes a container 210, such as an envelope, sleeve, box, shrink wrapped package and the like. Inside the kit 200 is a combination business form sample piece having a marketing message which is designated by reference numeral 220. The form assembly 220 has first and second parts that are delineated by line 221. First part is provided with a marketing message on the first and second sides 222 and 224 as well as supplemental marketing information at 226 and 228 as has been previously described herein.

The kit 200 also includes at least two additional product samples 230 and 240 which are substantially blank or devoid of indicia and which may be used for further demonstrating the particular sample being provided. Each of the sample forms 230 and 240 are provided with a line 231 and 241, respectively, that separate the forms into first and second parts. The sample forms 230 and 240 may also be provided with some limited indicia that is designated as 232 and 242 respectively. This supplemental indicia may include printer feeding information, removal details or such other limited information relating to the use of the product.

The kit 200 of this embodiment also includes a response sheet or card 250. The response sheet could be faxed off to the manufacturer's location to request a quotation or the response card could be inserted into the mail in order to get a quotation on the product or service that is being offered.

It will thus be seen according to the present invention a highly advantageous marketing communication with detachable element has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A business form marketing communication piece, comprising;
a business form having a first part that includes front and back faces, each of said front and back faces is printed with a marketing communication that includes at least two colors which do not include white or clear, said first part having first and second side edges and first and second end edges;
said business form having further a second part that has front and back faces, first and second side edges and first and second end edges, said second part having at least one separable element, and said second part is joined to said first part along one of said side edges or end edges;
said separable element is used to provide an interactive business form component to demonstrate use of said component in cooperation with said marketing communication provided on said first part.

2. A business form marketing communication as recited in claim 1, wherein said first part is joined to said second part by an adhesive tape or strip.

3. A business form marketing communication as recited in claim 1, wherein at least one face of said second part is provided with complimentary indicia to said marketing communication on said first part.

4. A business form marketing communication as recited in claim 1, wherein said separable element is selected from a group including wristbands, cards, labels, tags, tickets and combinations thereof.

5. A business form marketing communication as recited in claim 1, wherein said marketing communication is printed with at least four colors excluding white and clear.

6. A business form marketing communication as recited in claim 1, wherein said first part is provided with printing selected from a group including maps, use directions, suggested use applications, user testimonials, product pricing information, coupons and product discounts, promotional offerings and combinations thereof.

7. A business form marketing communication as recited in claim 1, wherein said first part is constructed of a first material and said second part is constructed from a second material distinct from said first part.

8. A method of marketing a business form product or business communication service, comprising the steps of;
assembling a first data set relating to a product or service;
preparing a full color layout for said product or service having at least two distinct colors other than white or clear;
obtaining a business form having at least a first part, said first part having first and second faces;
printing at least a first marketing communication on one of said first and second faces using said full color layout;
providing a second part, said second part having at least one removable element;
connecting said second part to said first part along an edge of each of said first and second parts through use of an adhesive strip to form a marketing communication;
distributing said marketing communication; and
calculating response rates.

9. A method as recited in claim 8, including a further step of collecting information on a group of end users interested in said product or service prior to the step of distributing said marketing communication.

10. A method as recited in claim 8, including a further step of folding and mailing said marketing communication prior to the step of distributing said marketing communication.

11. A method as recited in claim 8, wherein said product or service is related to printed products used in business communications.

12. A method as recited in claim 8, wherein said product or service is selected from an entertainment group including amusement parks, theme parks, concerts, museums, exhibits, zoos, fairs, events and combinations thereof.

13. A method as recited in claim 8, wherein said removable element is a wristband.

14. A method as recited in claim 8, wherein said method includes adding additional, substantially unprinted product samples prior to the step of distributing.

15. A method as recited in claim 8, wherein said step of preparing a full color layout includes producing a well known character equity.

16. A method as recited in claim 8, wherein said first marketing communication is selected from a group including maps, use directions, suggested use applications, user testimonials, product pricing information, coupons and product discounts, promotional offerings and combinations thereof.

17. A method as recited in claim 8, wherein said full color layout includes at least four colors excluding white or clear.

18. A method as recited in claim 8, wherein said first part is constructed of a first material and said second part is constructed from a second material distinct from said first part.

19. A method as recited in claim 8, including a further step of determining success of a marketing campaign after the step of calculating response rates.

20. A marketing promotional business forms product kit, comprising;
a first business form having first and second sections, said first section is printed with at least four colors other than white or clear to provide a marketing communication and said second section is provided with a removable element selected from a group including magnets, cards, wristbands, tickets, labels and combinations thereof, and use of said removable element is described by said marketing communication;
at least two demonstration forms, each of said demonstration business forms are substantially blank and have first and second sections, with one of said second sections having a removable element selected from a group including magnets, cards, wristbands, tickets, labels and combinations thereof; and
a container for holding said first business form and said at least two demonstration forms.

21. A business form marketing kit as recited in claim 20, wherein said kit includes product pricing sheets.

22. A business form marketing kit as recited in claim 20, wherein said container is an envelope.

23. A business form marketing kit as recited in claim 20, wherein said first and second parts of said business form are joined to one another by a strip of tape.

24. A business form marketing kit as recited in claim 20, wherein said first part is constructed of a first material and said second part is constructed from a second material distinct from said first part.

25. A business form marketing kit as recited in claim 20, wherein said kit includes an additional product information sheet and response form.
